(19) United States
(12) Patent Application Publication
(10) Pub. No.: US 2023/0280699 A1
(43) Pub. Date: Sep. 7, 2023

(54) ELECTRONIC DEVICE TO CREATE AUTOMATION ROUTINES AND THE METHOD FOR OPERATING SAME

(71) Applicant: SAMSUNG ELECTRONICS CO., LTD., Suwon-si, Gyeonggi-do (KR)

(72) Inventors: Seoyoung KO, Suwon-si (KR); Kyoungae KIM, Suwon-si (KR); Hyungjoo NAM, Suwon-si (KR); Bonheon KOO, Suwon-si (KR); Semin PARK, Suwon-si (KR); Sooah PARK, Suwon-si (KR); Dasom LEE, Suwon-si (KR)

(21) Appl. No.: 18/193,061

(22) Filed: Mar. 30, 2023

Related U.S. Application Data
(63) Continuation of application No. PCT/KR2023/002690, filed on Feb. 27, 2023.

(30) Foreign Application Priority Data
Mar. 7, 2022 (KR) 10-2022-0028975
Mar. 11, 2022 (KR) 10-2022-0030524

(51) Int. Cl. G05B 11/16; G05B 19/042; G06F 3/0486

(52) U.S. Cl. CPC G05B 11/16; G05B 19/042; G06F 3/0486; G05B 2219/2642

(57) ABSTRACT

An electronic device according to various embodiments includes: a display, a communication module comprising communication circuitry, a memory, and a processor operatively connected to the display, the communication module, and the memory, wherein the processor is configured to: receive, from at least one communicatively connected external electronic device, first operation information on an operating state of the at least one external electronic device; generate an automation pattern including an operation of the at least one external electronic device based on the first operation information; receive second operation information on the operating state of the at least one external electronic device from the at least one external electronic device after the reception of the first operation information; change the automation pattern based on a difference between the operating state of the at least one external electronic device included in the first operation information and the operating state of the at least one external electronic device included in the second operation information; and execute the automation pattern based on an input.

### CROSS-REFERENCE TO RELATED APPLICATIONS

This application is a continuation of International Application No. PCT/KR2023/002690 designating the United States, filed on Feb. 27, 2023, in the Korean Intellectual Property Receiving Office and claiming priority to Korean Patent Application No. 10-2022-0028975, filed on Mar. 7, 2022, in the Korean Intellectual Property Office, and to Korean Patent Application No. 10-2022-0030524, filed on Mar. 11, 2022, in the Korean Intellectual Property Office, the disclosures of all of which are incorporated by reference herein in their entireties.

### BACKGROUND

### Field

The disclosure relates to an electronic device, for example, to technique for generating and changing an automation pattern using an electronic device.

### Description of Related Art

With the development of mobile communication technology and hardware/software technology, a portable electronic device (hereinafter referred to as an electronic device) can implement various functions in addition to a conventional call function. The electronic device may establish a communication connection with various external devices and may control an external device communicatively connected based on a user's input on the electronic device.

The electronic device may store a command frequently used by a user or setting items frequently used by the user in relation to the communicatively connected external device, and may generate an automation pattern using the stored command and setting items. The automation pattern may include at least one of a conditional clause and a resultant clause. The conditional clause may refer to a condition for the automation pattern to be executed, and the resultant clause may refer, for example, to a result of the automation pattern triggered by the conditional clause.

In a conventional electronic device, in order to generate an automation pattern, settings for each external device must be individually performed on the electronic device, which is inconvenient. Since the user had to perform all the settings individually in a user interface, not only was the intuition low, but there was also a problem in that it took a long time.

### SUMMARY

Embodiments of the disclosure provide a time-efficient method of generating and changing an automation pattern for an external device using an electronic device as described above.

In accordance with an example embodiment of the present disclosure, an electronic device may include: a display, a communication module comprising communication circuitry, a memory, and a processor operatively connected to the display, the communication module, and the memory, wherein the processor may be configured to: receive, from at least one communicatively connected external electronic device, first operation information on an operating state of the at least one external electronic device; generate an automation pattern including an operation of the at least one external electronic device based on the first operation information; receive second operation information on the operating state of the at least one external electronic device from the at least one external electronic device after the reception of the first operation information; change the automation pattern based on a difference between the operating state of the at least one external electronic device included in the first operation information and the operating state of the at least one external electronic device included in the second operation information, and execute the automation pattern based on an input.

In accordance with an example embodiment of the present disclosure, a method of generating an automation pattern of an electronic device may include: receiving, from at least one communicatively connected external electronic device, first operation information on an operating state of the at least one external electronic device; generating an automation pattern including an operation of the at least one external electronic device based on the first operation information; receiving second operation information on the operating state of the at least one external electronic device from the at least one external electronic device after the reception of the first operation information; changing the automation pattern based on a change between the operating state of the at least one external electronic device included in the first operation information and the operating state of the at least one external electronic device included in the second operation information; and executing the automation pattern based on an input.

According to various example embodiments, an electronic device may generate an automation pattern as is when a user likes a current operating state of an external device, and may directly manipulate the external device in the real world without applying a complicated manipulation in a user interface on the electronic device, thereby it is possible to easily generate the automation pattern. According to an example embodiment, the electronic device may record a user's daily life pattern and may recommend settings frequently used in the external device.

In addition, effects that can be obtained or predicted due to various example embodiments of the electronic device according to the disclosure will be directly or implicitly disclosed in the detailed description of the embodiment of the electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example relationship between electronic devices in a network environment according to various embodiments;

FIG. 2 is a signal flow diagram illustrating example operations of an electronic device, an external device, and an external server according to various embodiments;

FIG. 3 is a block diagram illustrating an example configuration of an electronic device according to various embodiments;

FIGS. 4A and 4B are diagrams illustrating an example in which an electronic device generates an automation pattern based on a user input according to various embodiments;

FIG. 5 is a diagram illustrating an example in which a user manipulates an external device in real time to generate an automation pattern according to various embodiments;

FIG. 6 is a diagram illustrating an example in which an electronic device generates an automation pattern based on a usage history of an external device according to various embodiments;

FIGS. 7A and 7B are diagrams illustrating an example in which an electronic device corrects an automation pattern when the automation pattern is different from an actual usage history of an external device according to various embodiments;

FIGS. 8A and 8B are diagrams illustrating an example of testing an automation pattern generated by an electronic device according to various embodiments;

FIGS. 9A, 9B, 9C, 9D, 9E and 9F are diagrams illustrating an example user interface through which a user can intuitively generate an automation pattern according to various embodiments;

FIG. 10 is a flowchart illustrating an example method of generating and changing an automation pattern of an electronic device according to various embodiments; and

FIG. 11 is a flowchart illustrating an example method of generating an automation pattern or an automation scene by an electronic device according to various embodiments.

### DETAILED DESCRIPTION

Hereinafter, various example embodiments of the disclosure will be described in greater detail with reference to the accompanying drawings.

In describing the embodiments, descriptions of technical details that are well known in the art to which the disclosure pertains and are not directly related to the disclosure may be omitted. In addition, detailed descriptions of elements having substantially the same configuration and function may not be repeated.

For the same reason, some components in the accompanying drawings are exaggerated, omitted, or schematically illustrated, and the size of each component does not entirely reflect the actual size. Accordingly, the disclosure is not limited by the relative size or spacing drawn in the accompanying drawings.

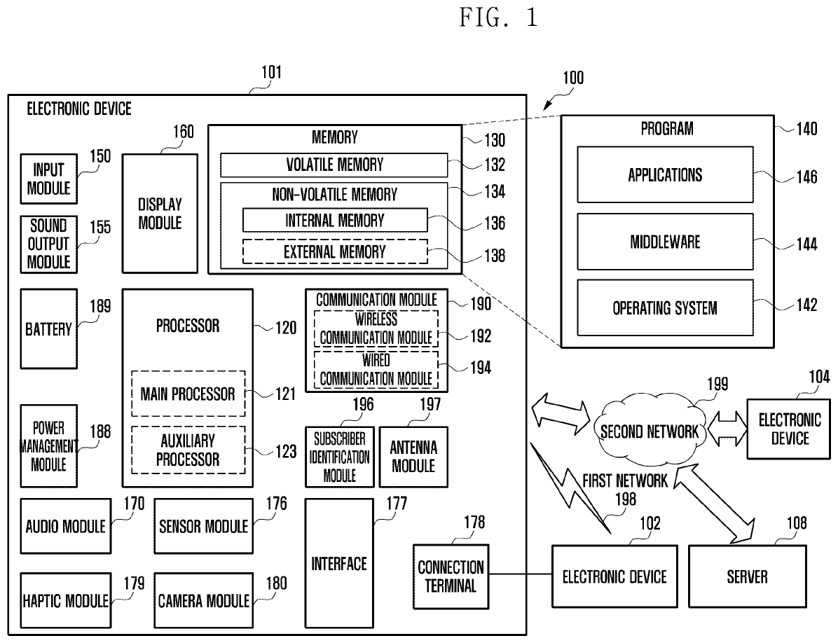

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An example method in which a processor generates an automation pattern will be briefly described as follows. The processor may establish a communication connection with at least one external device and receive operation information on an operating state from the at least one external device. The processor may generate an automation pattern including at least one external device and an operating state of each external device based on the received operation information. Hereinafter, the operation of the disclosure will be described in greater detail.

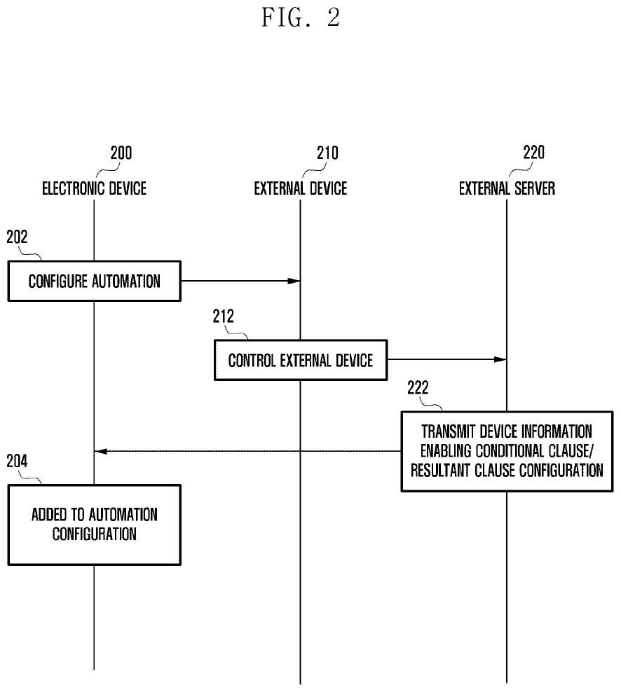

FIG. 2 is a signal flow diagram illustrating example operations of an electronic device, an external device, and an external server according to various embodiments.

Referring to FIG. 2, an electronic device 200 may establish a communication connection with at least one external device 210 and an external server 220. For example, the external device 210 may include home appliances (e.g., a computer, a refrigerator, a speaker, a monitor, a washing machine, and a lamp) located close to the electronic device 200. The electronic device 200 may receive operation information from the at least one external device 210 and may configure an automation pattern based on the received operation information in 202. The automation pattern may refer to a series of patterns in which the electronic device 200 controls the operation of the communicatively connected external device 210 in response to a configured trigger without a user's separate manipulation. The automation pattern may include the operation of the external device 210 and/or an operation sequence of the external electronic device 210. According to an embodiment, the automation pattern may include at least one of a conditional clause and a resultant clause. The conditional clause is a trigger for executing the automation pattern, and the resultant clause may refer to the operating state of the at least one external device 210 that occurs as a result of satisfying the conditional clause. Each of the conditional clause and resultant clause may include at least one option of the automation pattern. The electronic device 200 may store the generated automation pattern and then operate the external devices 210 included in the automation pattern at once based on a user input. The electronic device 200 may promote user convenience by operating the external devices 210 included in the automation pattern at once without individually performing the operation settings of all the external devices 210.

According to various embodiments, in 212, the electronic device 200 may control the at least one external device 210 based on the configured automation pattern. For example, when the electronic device 200 generates an automation pattern for turning off the power of a second external device when the power of a first external device is turned on, the electronic device 200 may control to turn off the power of the second external device in response to the power of the first external device being turned on.

According to various embodiments, the conditional clause and the resultant clause included in the automation pattern generated by the electronic device 200 may include the at least one external device 210. According to an embodiment, the determined external device 210 may, for example, be included in only one of the conditional clause and the resultant clause. According to an embodiment, the external device 210 may be included in both the conditional clause and the resultant clause. For example, when the external device 210 is a lamp, the external device 210 may be included in the conditional clause triggering the operation of another external device 210 and may also be included in the resultant clause. On the other hand, a time condition (e.g., at the time or sunset or sunrise) cannot be included in the resultant clause, but may be included only in the conditional clause. The electronic device 200 may establish a communication connection with the external server 220 and may acquire, in 222, information on a group in which the external device 210 may be included in the conditional clause and the resultant clause. The electronic device 200 may generate and change, in 204, the automation pattern based on the information acquired from the external server 220.

According to various embodiments, the electronic device 200 may be communicatively connected to the at least one external device 210 via the external server 220. For example, the electronic device 200 may establish a communication connection with the external server 220, and the at least one external device 210 may also establish a communication connection with the external server 220.

According to various embodiments, the electronic device 200 may receive operation information on the at least one external device 210 from the external server 220. For example, the at least one external device 210 may transmit the operation information to the external server 220, and the external server 220 may transmit the operation information to the electronic device 200 again. According to an embodiment, the electronic device 200 may transmit a control command to the at least one external device 210 through the external server 220. For example, the electronic device 200 may transmit a control command for the at least one external device 210 to the external server 220, and may transmit the control command received from the external server 220 to each external device 210 corresponding to the control command again. For example, the electronic device 200 may transmit, through the external server 220, a command for controlling the at least one external device 210 included in the pattern according to the configured automation pattern. According to an embodiment, the electronic device 200 may transmit the generated automation pattern to the external server 220, and the external server 220 may store the received automation pattern. When a trigger condition of the automation pattern is satisfied, the electronic device 200 may notify the external server 220 that the automation pattern has been triggered, and the external server 220 may instruct the at least one external device 210 corresponding to the automation pattern to perform a corresponding operation. According to an embodiment, the external server 220 may detect that the condition triggering the automation pattern is satisfied, and may notify the electronic device 200 of the execution of the automation pattern when detecting that the trigger condition for the automation pattern is satisfied.

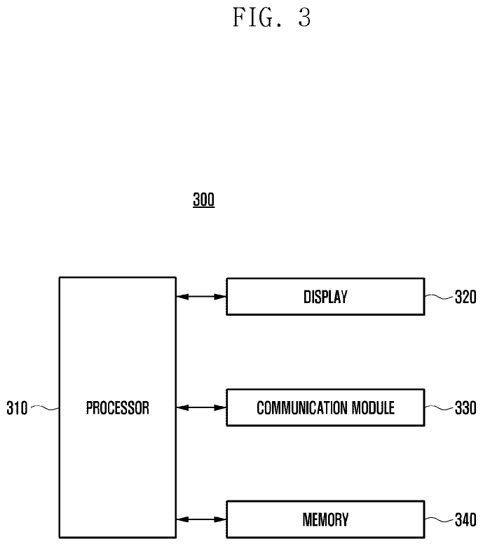

FIG. 3 is a block diagram illustrating an example configuration of an electronic device according to various embodiments.

Referring to FIG. 3, an electronic device 300 may include a display 320, a communication module (e.g., including communication circuitry) 330, a processor (e.g., including processing circuitry) 310, and a memory 340, and in various embodiments, some of the illustrated components may be omitted or substituted. The electronic device 300 may further include at least some of the components and/or functions of the electronic device 101 of FIG. 1. At least some of the illustrated (or not illustrated) components of the electronic device 300 may be operatively, functionally, and/or electrically connected to each other.

According to various embodiments, the display 320 may display various images under the control of the processor 310. The display 320 may be implemented, for example, and without limitation, as any one of a liquid crystal display (LCD), a light-emitting diode (LED) display, a micro LED display, a quantum dot (QD) display, an organic light-emitting diode (OLED) display, or the like, but is not limited thereto. The display 320 may be provided as a touch screen that detects a touch and/or proximity touch (or hovering) input using a user's body part (e.g., a finger) or an input device (e.g., a stylus pen). The display 320 may include at least some of the components and/or functions of the display module 160 of FIG. 1.

According to various embodiments, at least a portion of the display 320 may be flexible, and the display 320 may be implemented as a foldable display or a rollable display.

According to various embodiments, the communication module 330 may include various communication circuitry and communicate with an external device through a wireless network under the control of the processor 310. The communication module 330 may include hardware and software modules for transmitting and receiving data to and from a cellular network (e.g., a long term evolution {LTE} network, a 5G network, or a new radio {NR} network) and a short-range network (e.g., Wi-Fi or Bluetooth). The communication module 330 may include at least some of the components and/or functions of the communication module 190 of FIG. 1.

According to various embodiments, the memory 340 may include a volatile memory (e.g., the volatile memory 132 of FIG. 1) and a non-volatile memory (e.g., the non-volatile memory 134 of FIG. 1), and may temporarily or permanently store a variety of data. The memory 340 may include at least some of the components and/or functions of the memory 130 of FIG. 1 and may store the program 140 of FIG. 1.

According to various embodiments, the memory 340 may store various instructions that may be executed by the processor 310. These instructions may include control commands such as arithmetic and logical operations, data movement, input/output, and the like that may be recognized by the processor 310.

According to various embodiments, the processor 310 may be a component that is operatively, functionally, and/or electrically connected to each component (e.g., the display 320, the communication module 330, or the memory 340) of the electronic device 300 and performs calculation or data processing related to the control and/or communication of the components. The processor 310 may include at least some of the components and/or functions of the processor 120 of FIG. 1.

According to various embodiments, calculation and data processing functions that the processor 310 can implement on the electronic device 300 will not be limited, but hereinafter, various embodiments for generating and changing an automation routine will be described. Operations of the processor 310 to be described in greater detail below may be performed by loading instructions stored in the memory 340.

According to various embodiments, the processor 310 may include various processing circuitry and execute a predetermined (e.g., specified) application based on a user input in order to generate an automation pattern. The application may provide a user interface for configuring the conditional clause and resultant clause of the automation pattern. The processor 310 may configure the conditional clause and resultant clause of the automation pattern based on the user input through the user interface.

According to various embodiments, the processor 310 may establish a communication connection with at least one external device. The processor 310 may establish a communication connection with at least one external device located in a short distance using the communication module 330. For example, the processor 310 may establish a communication connection with various home appliances in the home.

According to various embodiments, the processor 310 may receive operation information from the at least one external device. The operation information may include power and various operating characteristics of the external device. For example, when the external device is a lamp, the operation information may include characteristics such as brightness and color of the lamp, and when the external device is an air conditioner, the operation information may include characteristics such as cooling temperature, operating mode, and wind speed of an air conditioner.

According to various embodiments, the processor 310 may generate the automation pattern based on the operation information received from the at least one external device. The automation pattern may refer to a series of patterns in which the electronic device 300 controls the operation of the communicatively connected external device 210 in response to a configured trigger without a user's separate manipulation. The automation pattern may include the operation of the external device 210 and/or an operation sequence of the external electronic device 210. The automation pattern may include at least one of a conditional clause and a resultant clause, and the conditional clause and resultant clause may include at least one option. The option that can be included in the conditional clause and the resultant clause may include the operating state and time option of the external device. According to an embodiment, the automation pattern generated by the processor 310 may include a current operating state of the external device. The processor 310 may change at least a portion of the automation pattern based on a user input. An embodiment in which the processor 310 changes the automation pattern based on the user input will be described in detail with reference to FIG. 3 later.

According to various embodiments, the processor 310 may generate the automation pattern in response to a real-time change in the operating state of the external device. The processor 310 may continuously receive operation information from the external device. When the operation information of the external device is changed while the processor 310 configures the automation pattern, the processor 310 may include the changed operation information in the automation pattern. For example, when the operating state of the external device is changed from a first state to a second state while the processor 310 is configuring the automation pattern, the processor 310 may include the second state of the external device as an option of the resultant clause of the automation pattern. This is to enable a user to conveniently configure the automation pattern by changing the operating state of the external device in real time in order for the user to configure the automation pattern.

According to various embodiments, the processor 310 may analyze the usage history of a device operated by the user and may recommend a frequently used setting value as automation. The processor 310 may generate usage history information based on the operation information received from the external device. The usage history information may include, for example, operation information of the external device for a predetermined period of time. The processor 310 may analyze the usage history information to determine a frequently used setting value for the external device by the user. The processor 310 may generate the automation pattern based on the determined setting value.

According to various embodiments, the processor 310 may generate the automation pattern according to the operating situation of the external device. The automation pattern may be classified into an automation routine or an automation scene depending on whether the conditional clause is included. The automation routine may be a pattern including both the conditional clause and the resultant clause, and the automation scene may be an automation pattern including only the resultant clause without the conditional clause. The processor 310 may generate the automation routine based on the usage history information of the external device when there is a trigger that precedes the operation of the external device, and may generate the automation scene when there is no trigger that precedes the operation of the external device.

According to various embodiments, the processor 310 may change the automation pattern when the generated automation pattern and an actual operation history of the device are different. According to an embodiment, when the user always uses another external device not included in the automation pattern upon executing the automation pattern, the processor 310 may correct the other external device to be included in the automation pattern. According to an embodiment, when the user uses the external device with an operation different from that configured in the automation pattern upon executing the automation pattern, the processor 310 may change the operating state of the external device in the automation pattern.

According to various embodiments, the processor 310 may provide a function of testing the automation pattern. According to an embodiment, the automation pattern test may be executed only in the case of the automation routine including both the conditional clause and the resultant clause. The processor 310 may execute a test for at least one of options included in the conditional clause. According to an embodiment, the processor 310 may classify and display a test executable option and an unexecutable option. For example, a time option may be an impossible condition to perform testing. The processor 310 may test the automation pattern by assuming a situation in which at least some of the testable conditions occur.

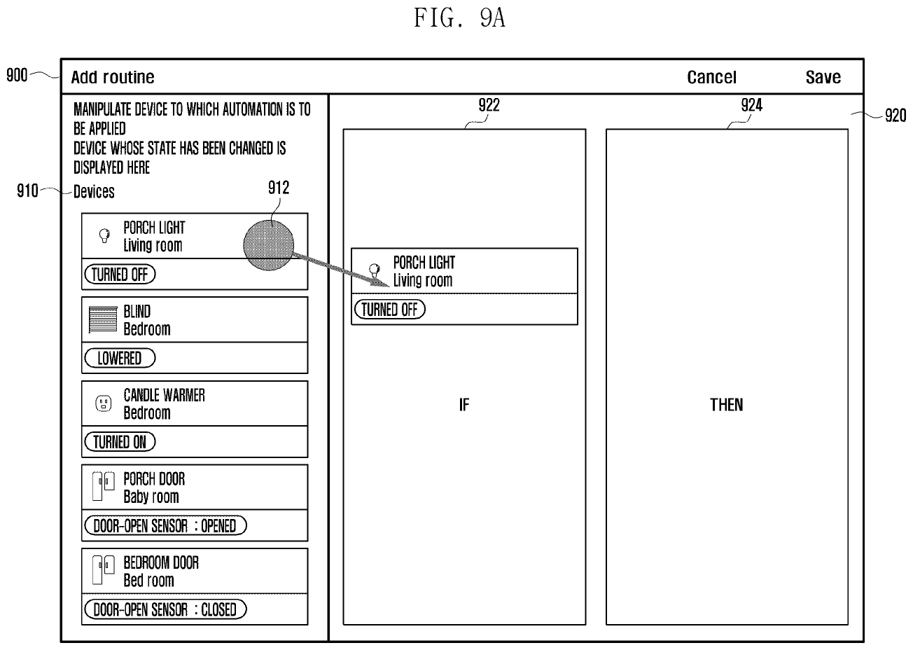

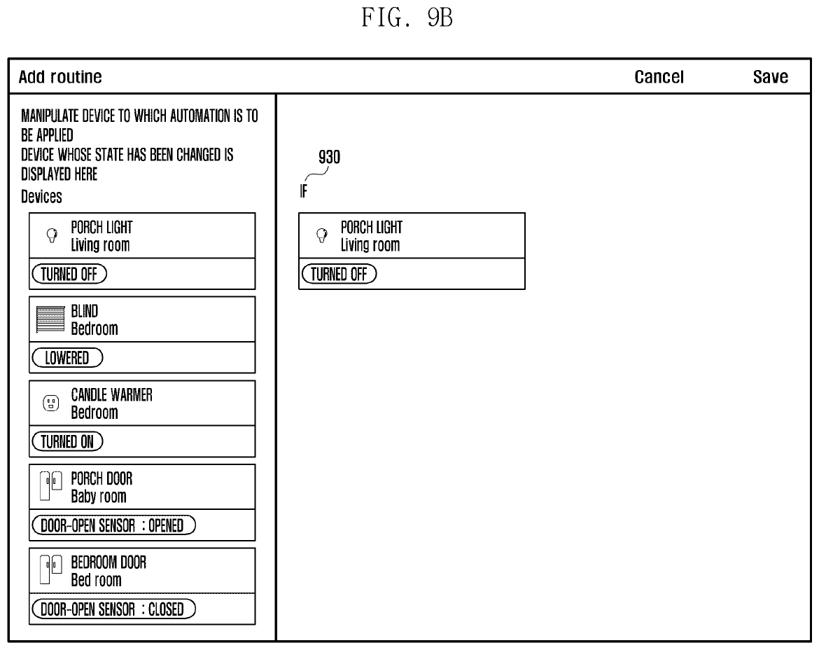

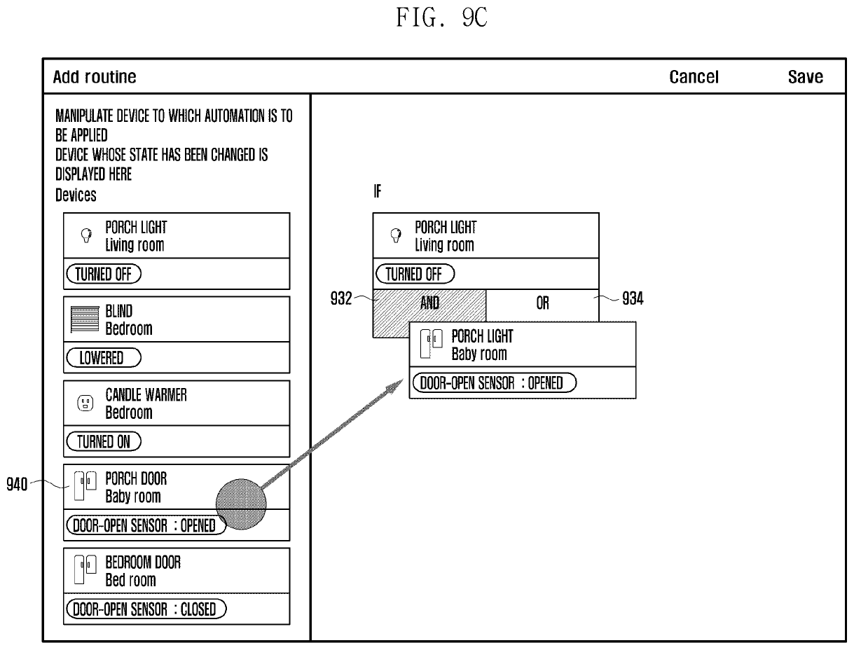

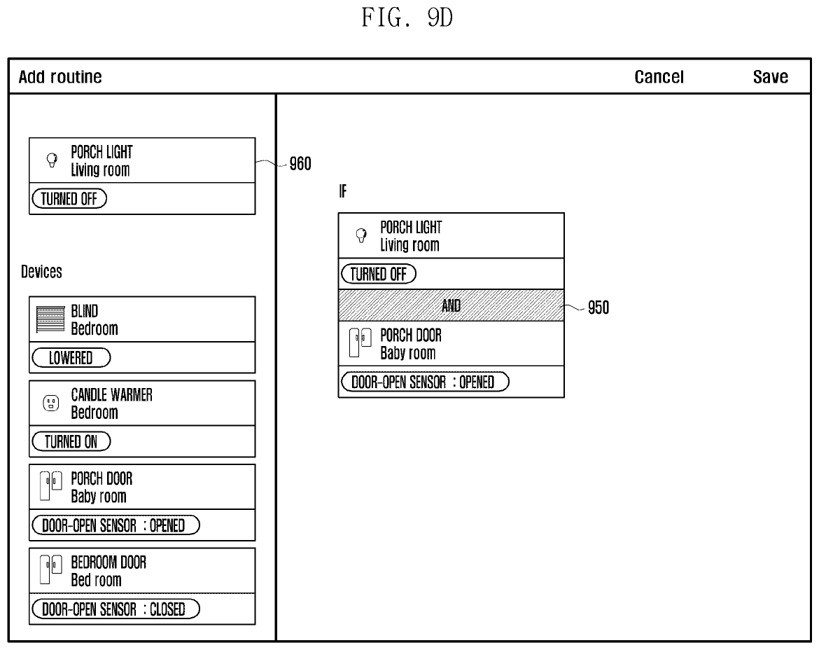

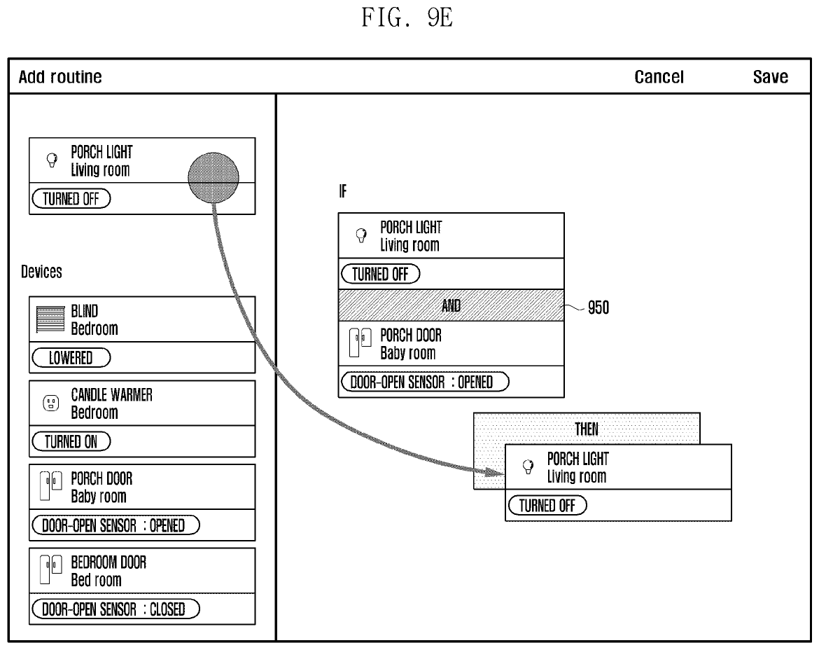

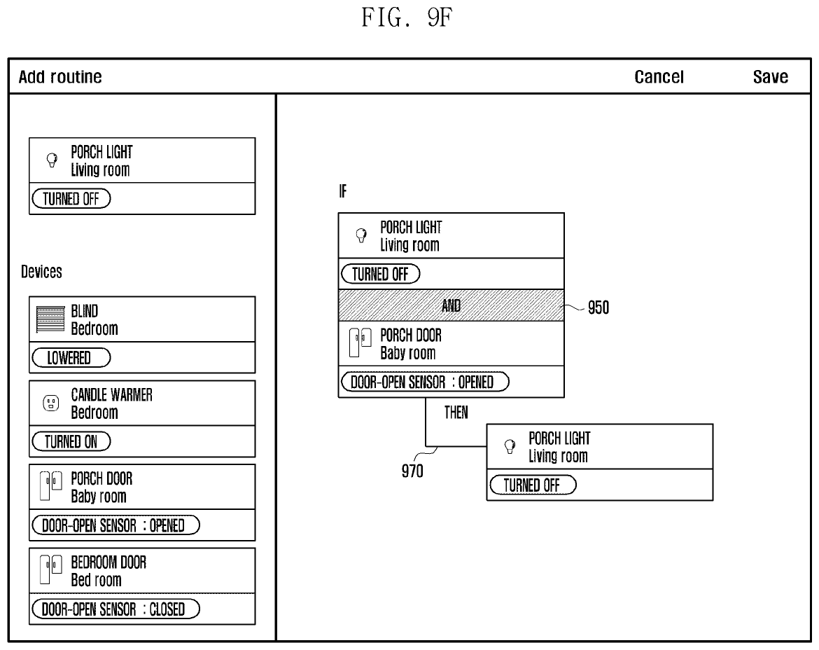

According to various embodiments, the processor 310 may support a drag-and-drop user interface for intuitive automation pattern generation. The processor 310 may provide a user interface including a list including at least one external device, a conditional clause box, and a resultant clause box. The processor 310 may guide the user to intuitively configure the automation pattern by dragging and dropping the external device selected from the list into the conditional clause box or the resultant clause box. A method of configuring the automation pattern using the drag-and-drop method will be described in detail later with reference to FIGS. 9A to 9F.

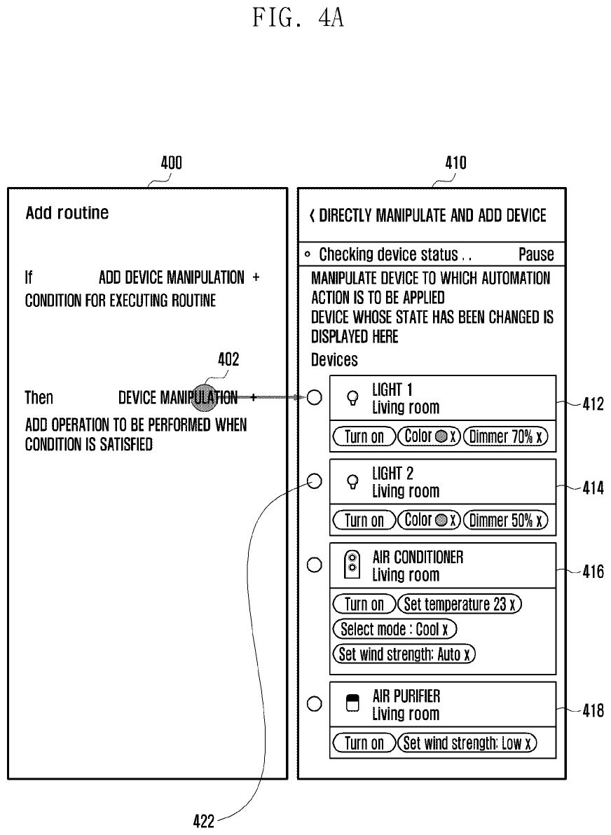

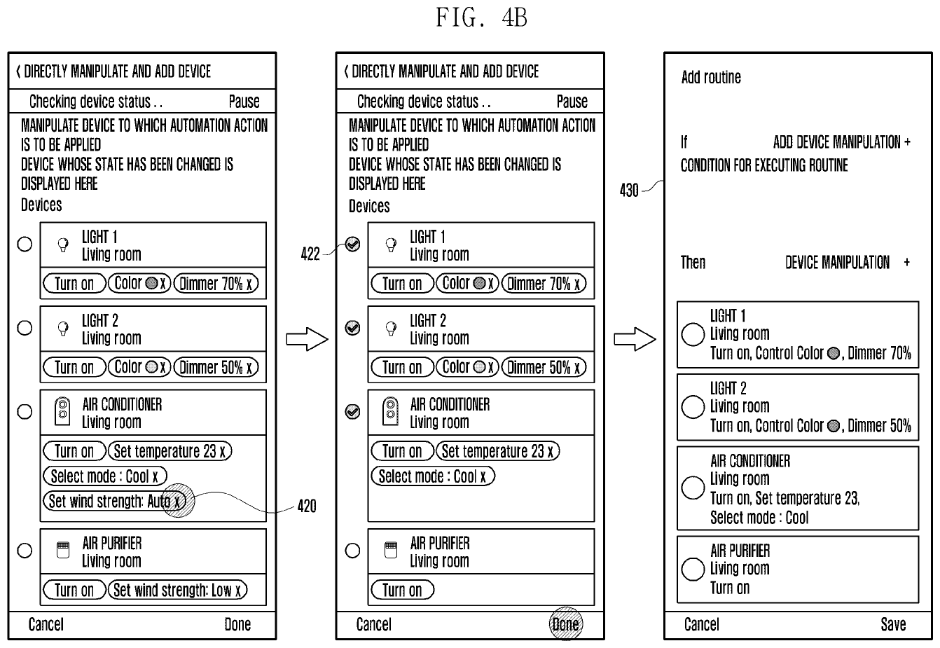

FIGS. 4A and 4B are diagrams illustrating an example in which an electronic device generates an automation pattern based on an input (e.g., a user input) according to various embodiments.

A brief description of an example method in which a processor (e.g., the processor 310 of FIG. 3) generates an automation pattern based on a user input will be described as follows. The processor 310 may display a first screen 400 for configuring a conditional clause and a resultant clause or a second screen 410 for configuring a specific option. The processor 310 may configure the automation pattern based on a user input for a check box 422 and an operating state on the second screen 410. The operation of the embodiment of the disclosure will be described in greater detail below with reference to FIGS. 4A and 4B.

Referring to FIG. 4A, the processor 310 may execute a predetermined (e.g., specified) application based on the user input in order to generate the automation pattern. The application may provide a user interface for configuring the conditional clause and resultant clause of the automation pattern. The first screen 400 for configuring the conditional clause and the resultant clause may further include an indicator including a brief description of the conditional clause and the resultant clause and a configuration button 402. The processor 310 may display the second screen 410 based on a user input to the configuration button 402. The second screen 410 may include a user interface capable of adding external devices to the conditional or resultant clauses through manipulation. The processor 310 may display graphic objects corresponding to at least one external device, the indicator, and boxes 412, 414, 416, and 418 including at least one option for each external device, and the second screen 410 including the check box 422 for selecting each external electronic device. For example, the second screen 410 may include a first box including a first option, a second option, and a third option of a first external device, a second box including a first option, a second option, and a third option of a second external electronic device, and the check box 422 located on one side of each of the first box and the second box.

Referring to FIG. 4B, the processor 310 may configure the automation pattern based on a user input for the option and the check box 422. The processor 310 may include the external device corresponding to the selected check box 422 in the automation pattern based on the user input for the check box 422, and may exclude the external device from an automation state when the user presses the check box 422 once more. The processor 310 may determine the operating state when the automation pattern of the external device is executed based on the user input for each option of the selected external device. For example, the processor 310 may determine whether to include each option in the operation of the external device based on the user input. For example, the processor 310 may remove, in 420, the first option from the automation pattern based on the user input for the first option of the first external device. According to an embodiment, the processor 310 may output a confirmation message that the option is removed from the automation pattern before removing the option from the automation pattern.

According to various embodiments, the processor 310 may generate the automation pattern based on the received operation information. The processor 310 may generate the automation pattern based on a currently operating state. For example, the processor 310 may receive operation information of each of lighting 1, lighting 2, an air conditioner, and an air purifier, which are currently and communicably connected external devices. For example, light 1 may be powered on, have a first color, and operate at a first brightness (e.g., 70%), light 2 may be powered on, have a second color, and operate at a second brightness (e.g., 50%). The air conditioner may be powered on, have a configuration temperature of a first temperature (e.g., 23 degrees), have an operation mode of a first mode (e.g., a cooling mode), and operate at a wind speed of a first intensity (e.g., an automatic mode). The air purifier may be powered on and have a wind speed of a second intensity (e.g., weak). The processor 310 may receive the operation information of each external device and may display the received information on a display (e.g., the display 320 of FIG. 3). According to an embodiment, the processor 310 may change the automation pattern based on the user input. The method for the user to configure the automation pattern using the user interface is as described above.

According to various embodiments, the processor 310 may configure the external device included in the conditional clause and the resultant clause and its option in the above-described method. The processor 310 may store, in 430, the automation pattern based on the user input, and then may control, when the automation pattern is executed even if there is no manipulation of individual external devices, to perform the operation of the external devices stored in the pattern.

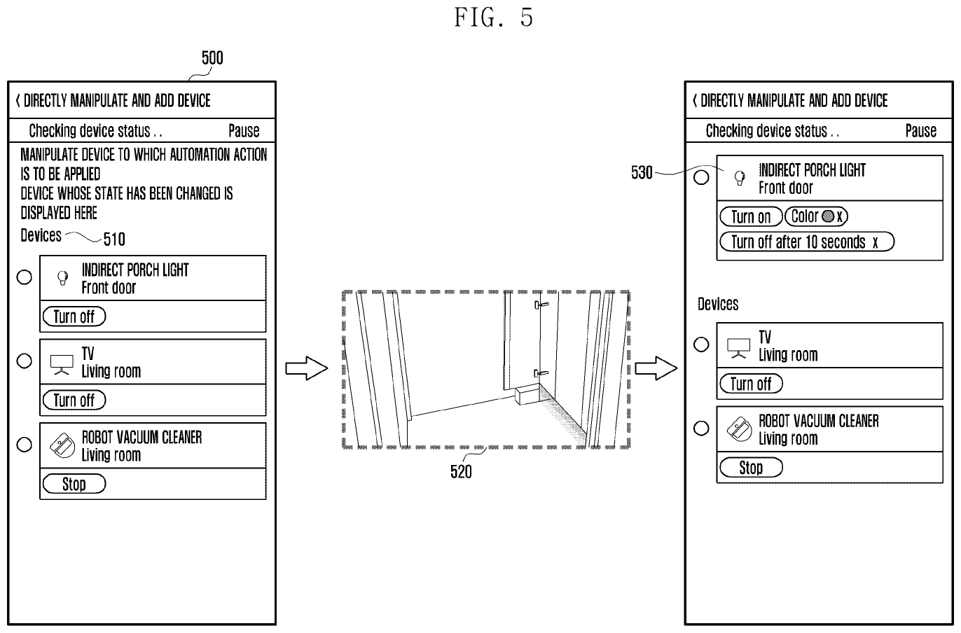

FIG. 5 is a diagram illustrating an example in which a user generates an automation pattern by manipulating an external device in real-time according to various embodiments.

Referring to FIG. 5, a processor (e.g., the processor 310 of FIG. 3) may detect an operating state of an external device that is changed in real time. According to various embodiments, the processor 310 may continuously receive operation information from the external device, and may detect, when a user changes the operating state of the external device, that the operating state of the external device has been changed by comparing the operation information received after the change in the operating state with previously received operation information. When the received operation information received while the processor 310 manipulates the external device on the second screen is different from the previously received operation information, the processor 310 may change the automation pattern based on a difference between the two pieces of operation information. For example, on the first screen 500, the processor 310 may display a list 510 including at least one external device to configure the automation pattern. For example, the processor 310 may display the list 510 including an indirect porch light, a TV, and a robot vacuum cleaner. When the indirect light at the front door is operated in 520 while configuring the automation pattern including the indirect porch light, the TV, and the robot vacuum cleaner, the processor 310 may add the operating state of the indirect porch light to the automation pattern. For example, when an operation of emitting light in a first color while the indirect porch light is operated and turning off the indirect porch light after 10 seconds is performed, the processor 310 may add, in 530, an option such as the operation of the indirect porch light to the automation pattern. In this way, the user can easily configure the automation pattern by actually operating the external device without having to configure the external devices one by one in the electronic device.

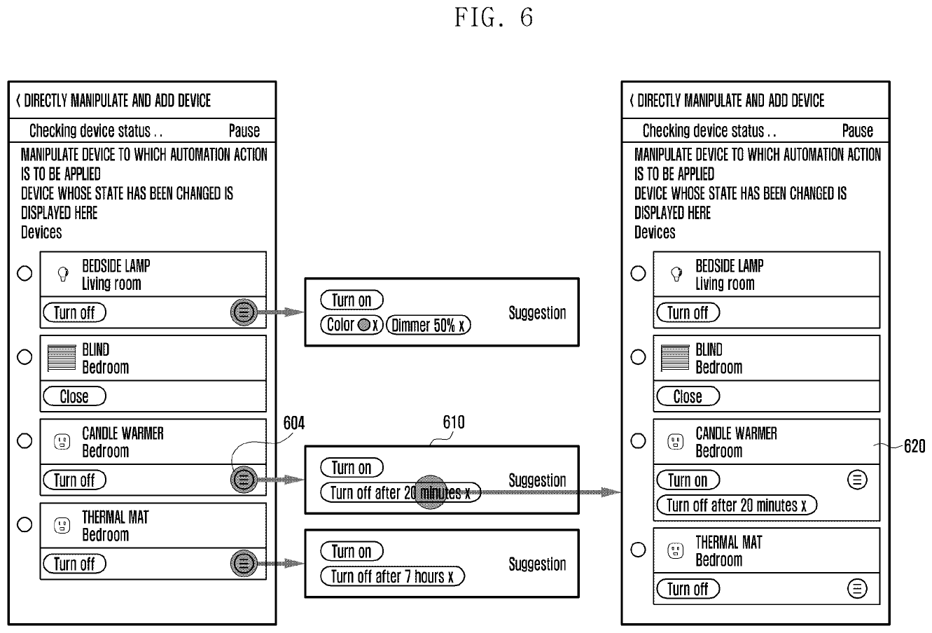

FIG. 6 is a diagram illustrating an example in which an electronic device generates an automation pattern based on usage history of an external electronic device according to various embodiments.

According to various embodiments, a processor (e.g., the processor 310 of FIG. 3) may store information on an operating state of an external device in a memory (e.g., the memory 340 of FIG. 3). The processor 310 may generate usage history information including accumulated information on the operational state for a predetermined period of time for each external device. The processor 310 may generate a user-customized automation pattern with reference to the usage history information. Referring to FIG. 6, the processor 310 may display a list including at least one external device. The processor 310 may display a recommendation menu 604 in a box corresponding to the at least one external device among the external devices included in the list. The recommendation menu 604 may be generated based on the usage history information of the external device stored in the memory 340 among the external devices included in the list. According to an embodiment, the processor 310 may generate the recommendation menu 604 for the external device included in the usage history information stored in the memory 340. The processor 310 may display an option 610 of the automation pattern generated according to the usage history of each external device based on a user input for the recommendation menu 604. For example, the processor 310 may display the recommendation menu 604 and the option 610 for a bedside lamp, a candle warmer, and a thermal mat. The processor 310 may recommend an option that turns on the power, uses a first color, and has a brightness of 50% for the bedside lamp, may recommend an option that turns on the power and turns off the power after 20 minutes for the candle warmer, and may recommend an option that turns on the power and turns off the power after 7 hours for the thermal mat. FIG. 6 illustrates some of the operation options of the external device that the electronic device can recommend, and the disclosure is not limited thereto.

According to various embodiments, the processor 310 may generate the automation pattern based on a user input for the recommended option 610. For example, when the user wants to use all of the recommended options, the processor 310 may generate the automation pattern including all of the recommended options. According to an embodiment, the processor 310 may generate the automation pattern excluding some of the recommended options based on the user input. For example, when the user touches only the recommendation menu 604 for the candle warmer, the processor 310 may generate the automation pattern including only the box 620 corresponding to the candle warmer.

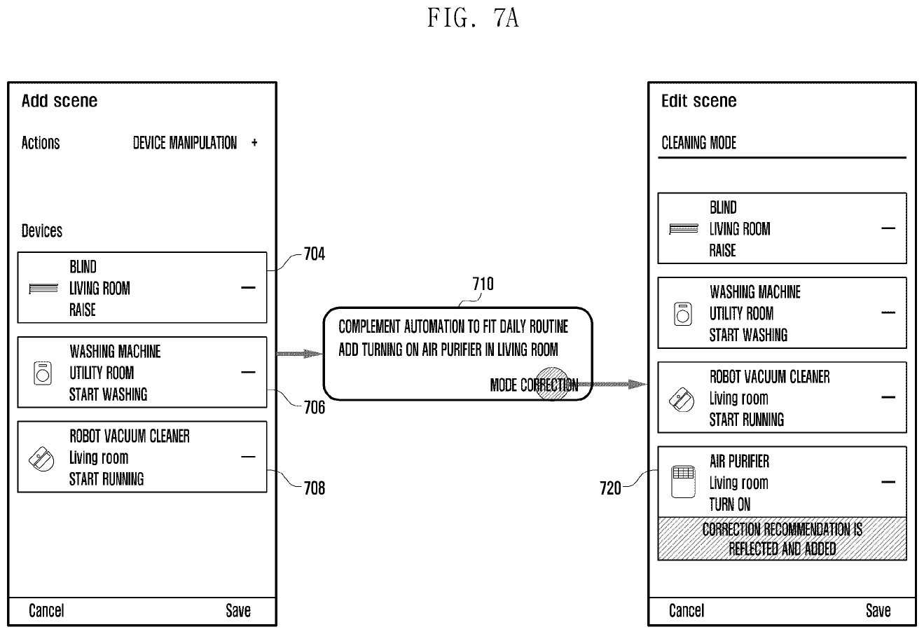

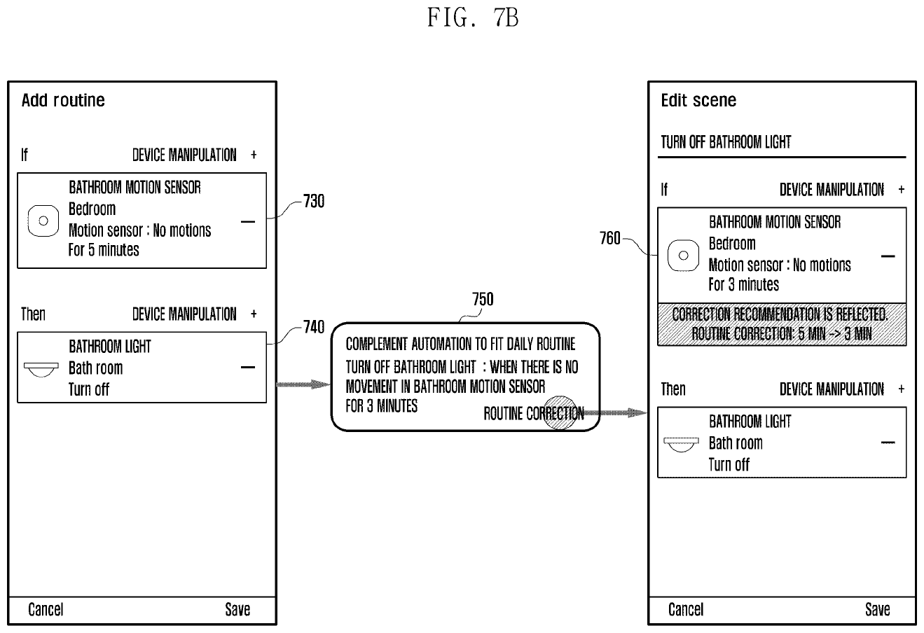

FIGS. 7A and 7B are diagrams illustrating an example in which an electronic device corrects an automation pattern when the automation pattern is different from an actual usage history of an external electronic device according to various embodiments.

According to various embodiments, a processor (e.g., the processor 310 of FIG. 3) may correct an automation pattern when the automation pattern is different from an actual usage history of an external device. Referring to FIG. 7A, when another external device not included in the automation pattern is used together while the automation pattern is being executed, the processor 310 may include the external device in the automation pattern. The processor 310 may change the automation pattern when a frequency of using the external device together with the automation pattern is greater than or equal to a predetermined value. For example, the processor 310 may generate the automation pattern including a blind 704, a washing machine 706, and a robot vacuum cleaner 708. When a frequency of using the air purifier during execution of the automation pattern is greater than or equal to a predetermined value (e.g., two times out of five times), the processor 310 may include the air purifier in the automation pattern. According to an embodiment, the processor 310 may output a message 710 for correcting the automation pattern according to a user's usage pattern of the external device. For example, when adding the air purifier to the automation pattern, the processor 310 may output the message 710 indicating that the air purifier will be added to the already generated automation pattern. The processor 310 may change, in 720, the automation pattern based on the user input to the message 710.

Referring to FIG. 7B, the processor 310 may correct the automation pattern when the operating state of the external device included in the automation pattern is different from the set operating state while the automation pattern is being executed. The processor 310 may change the automation pattern when a frequency at which the operating state of the external devices included in the automation pattern is different from the configured operating state is equal to or greater than the predetermined value (e.g., two times out of five times). For example, in a state in which an automation pattern of turning off a bathroom light 740 is configured when there is no movement is detected by a bathroom motion sensor 730 for 5 minutes, when a frequency at which the user turns off the bathroom light is greater than or equal to a predetermined value while there is no movement from the bathroom motion sensor 730 for 3 minutes, the processor 310 may correct a conditional clause in the automation pattern. According to an embodiment, the processor 310 may guide the user to correct the automation pattern by outputting a guidance message 750 for correcting the conditional clause. The processor 310 may change, in 760, the automation pattern based on a user input for the message 750. For example, when no movement is detected by the bathroom motion sensor for 3 minutes, the automation pattern may be changed in 760 by turning off the bathroom light. The processor 310 may change the automation pattern based on a box corresponding to each external device on a second screen and a user input for an option included in the box as well as the user input for the guidance message 750.

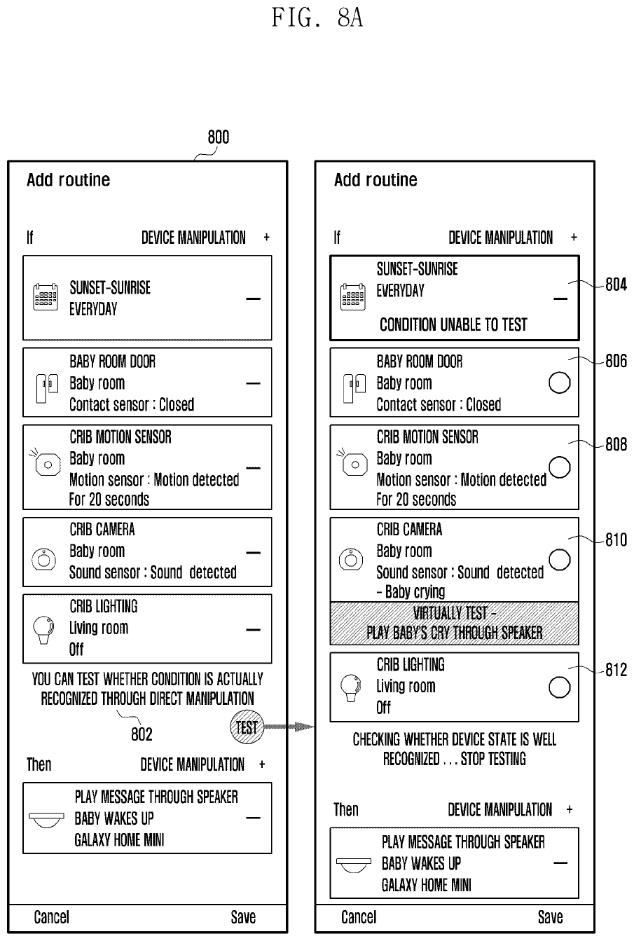

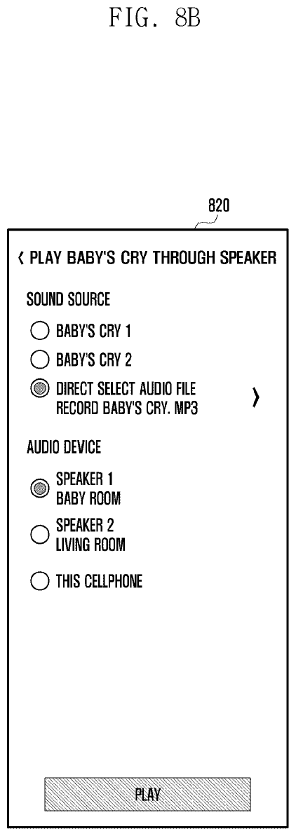

FIGS. 8A and 8B are diagrams illustrating an example of testing an automation pattern generated by an electronic device according to various embodiments.

According to various embodiments, a processor (e.g., the processor 310 of FIG. 3) may provide a function for testing an automation pattern. Referring to FIG. 8A, the processor 310 may provide a test button 802 and an indicator for the test function on one area of a first screen 800. The processor 310 may perform a test for the automation pattern based on a user input to the test button 802.

According to various embodiments, the processor 310 may classify and display testable options and untestable options among various options included in the conditional clause. According to an embodiment, the processor 310 may acquire information on the untestable options from the external server. For example, a time condition 804 may be included in the untestable option. The processor 310 may perform tests on a door sensor 806, a bed motion sensor 808, a bed camera 810, and a bed light 812. In the automation pattern, when a baby room door is closed, the motion sensor 808 of a crib detects movement at an interval of 20 seconds, a baby's cry is detected through the camera 810 of the crib, and the light 812 of the crib is turned off, the electronic device may output a message indicating that the baby has woken up. The processor 310 may test the automation pattern based on a user input. For example, the processor 310 may control the camera 810 to detect the baby's cry by virtually playing the sound of the baby's cry, and the electronic device may determine, when the remaining external devices are set to an operating state required for executing the automation pattern, whether the message indicating that baby has woken up is output.

Referring to FIG. 8B, the processor 310 may set an option for an automation pattern test. For example, the processor 310 may play a baby's cry recorded for a test through a speaker. The processor 310 may provide a user interface 820 through which an option for a test may be set, to a user. For example, the processor 310 may provide a menu for selecting a sound source to be played from among a pre-stored baby's cry sound and the recorded baby's cry sound stored in the electronic device. For example, the processor 310 may select one of a speaker in a baby room, a speaker in a living room, and an electronic device as the external device to play the predetermined baby's cry sound source.

FIGS. 9A, 9B, 9C, 9D, 9E and 9F are diagrams illustrating an example user interface capable of intuitively generating an automation pattern by a user according to various embodiments.

According to various embodiments, a processor (e.g., the processor 310 of FIG. 3) may provide a user interface capable of intuitively generating an automation pattern by a user. A method of generating an automation pattern that can be provided by the processor 310 is not limited to a drag-and-drop method described with reference to FIGS. 9A, 9B, 9C, 9D, 9E and 9F (which may be referred to as FIGS. 9A to 9F), and the automation pattern may be generated through the user interface described with reference to FIGS. 2 to 8.

Referring to FIG. 9A, the processor 310 may generate a user interface 900 including a list 910 including at least one externa device and an automation pattern generation area 920 including a conditional clause box 922 and a resultant clause box 924. The list 910 may include a graphic object corresponding to the at least one external device and various options for the operating state of the external device. According to an embodiment, the processor 310 may configure various operating states of the external device based on a user input to the graphic object. The user may drag and move the external device desired to be included in the automation pattern. The processor 310 may detect a user's drag input to one of the external devices included in the list 910 and may move the position of a graphic object indicating the drag-input external device. For example, when the user touches and drags a first graphic object 912 (e.g., a graphic object indicating a porch light), the processor 310 may change the position of the first graphic object 912 according to the drag input.

Referring to FIG. 9B, the processor 310 may input, in 930, the external device to a conditional clause or a resultant clause based on a user's drag and drop. The user may drop the dragged graphic object in a conditional clause box or a resultant clause box. For example, when the first graphic object 912 dragged by the user is dropped in the conditional clause, the processor 310 may input, in 930, the external device corresponding to the first graphic object 912 as one of the options included in the conditional clause.

Referring to FIG. 9C, the processor 310 may add another option to the conditional clause based on a user's drag and drop touch input. According to an embodiment, when a touch input to another user's graphic object is detected, the processor 310 may activate icon menus 932 and 934 for generating an automation pattern at the bottom of the graphic object already located in the conditional clause. The icon menus 932 and 934 may include an AND menu 932 that must occur along with the operation of the external device previously located in the conditional clause and an OR menu 934 that may optionally occur along with the operation of the external device previously located in the conditional clause. For example, when the user drags a second graphic object 940 (e.g., a graphic object indicating a porch door) and drops the second graphic object 940 on the AND menu 932 at the bottom of the first graphic object 912, the conditional clause may be configured in such a manner that the external device corresponding to the first graphic object 912 and the external device corresponding to the second graphic object 940 simultaneously satisfy a specified condition. For example, when the user drags the second graphic object 940 and drops the second graphic object 940 on the OR menu 934 at the bottom of the first graphic object 912, the conditional clause may be configured in such a manner that any one of the external device corresponding to the first graphic object 912 or the external device corresponding to the second graphic object 940 satisfies the specified condition.

Referring to FIG. 9D, the processor 310 may display a bar 950 connecting the first graphic object 912 and the second graphic object 940 based on the menu in which the second graphic object 940 is dropped. For example, when the user drops the second graphic object 940 on the AND menu at the bottom of the first graphic object 912, the processor 310 may connect the first graphic object 912 and the second graphic object 940 through the AND bar 950 shown in FIG. 9D.

Referring to FIG. 9E, the processor 310 may generate the resultant clause in the same or similar manner as generating the conditional clause. The processor 310 may generate the resultant clause by recognizing a user's drag and drop touch input for a graphic object. Referring to FIG. 9F, the processor 310 may complete the automation pattern by connecting the completed conditional clause and resultant clause with a line 970.

An electronic device according to various example embodiments may include a display, a communication module comprising communication circuitry, a memory, and a processor operatively connected to the display, the communication module, and the memory, wherein the processor may be configured to: receive, from at least one communicatively connected external electronic device, first operation information on an operating state of the at least one external electronic device; generate an automation pattern including an operation of the at least one external electronic device based on the first operation information; receive second operation information on the operating state of the at least one external electronic device from the at least one external electronic device after the reception of the first operation information; change the automation pattern based on a difference between the operating state of the at least one external electronic device included in the first operation information and the operating state of the at least one external electronic device included in the second operation information, and execute the automation pattern based on an input.

According to various example embodiments, the processor may be configured to: detect, based on a user changing the operating state of the at least one external electronic device, that the operating state of the at least one external device is changed in real time, and may change the automation pattern in response to detecting that the operating state of the at least one external device is changed.

According to various example embodiments, the processor may be configured to generate an automation pattern including both at least one conditional clause including an operating condition of the automation pattern and at least one resultant clause including an operating result, or an automation pattern including only the at least one resultant clause.

According to various example embodiments, the processor may be configured to generate usage history information of each external device based on the operation information received from the at least one external device, and to generate the automation pattern based on the usage history information.

According to various example embodiments, the processor may be configured to: determine whether a frequency at which the external device operates in a specific operating state satisfies a designated condition based on the usage history information, and determine, based on the frequency satisfying the designated condition, whether there is a trigger that precedes the specific operating state, and generate an automation pattern including the at least one conditional clause and the at least one resultant clause based on the trigger and generate an automation pattern including only the at least one resultant clause base on there being no trigger.

According to various example embodiments, the processor may be configured to receive the operation information from the external device based on the automation pattern being executed, and change, based on there being a difference between the operation information and the automation pattern, the automation pattern based on the difference.

According to various example embodiments, the processor may be configured to provide a test function of the generated automation pattern.

According to various example embodiments, the processor may be configured to determine at least one of the conditional clauses included in the automation pattern as a testable conditional clause to provide a test function.

According to various example embodiments, the processor may be configured to: output at least one graphic object including an indicator indicating the operating state of the at least one external device to the display based on the first operation information, and change the at least one graphic object and output the changed graphic object to the display based on a difference between the operating state of the at least one external device included in the first operation information and the operating state of the at least one external device included in the second operation information.

According to various example embodiments, the processor may be configured to: move, based on a drag input to a graphic object corresponding to the external electronic device, the position of the graphic object within the display, to activate a conditional clause box and a resultant clause box, and generate the automation pattern in response to the graphic object being dropped in the conditional clause box or the resultant clause box.

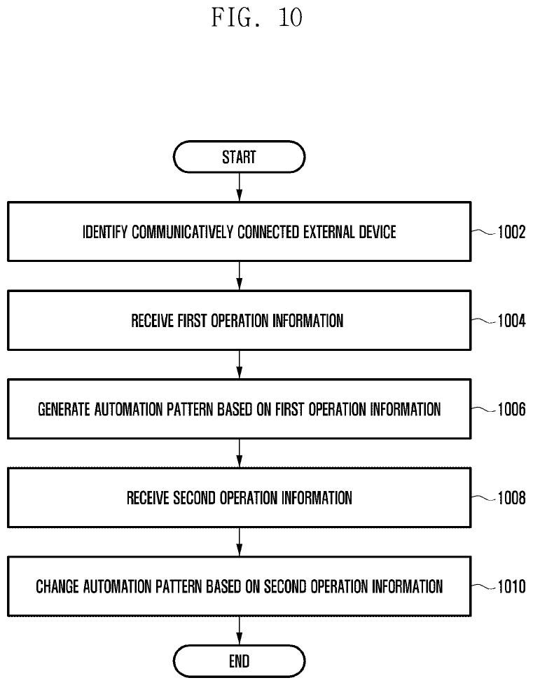

FIG. 10 is a flowchart illustrating an example method of generating and changing an automation pattern of an electronic device according to various embodiments.

The method shown in FIG. 10 may be performed by the electronic device described with reference to FIGS. 1 to 9F (e.g., the electronic device 101 of FIG. 1 or the electronic device 300 of FIG. 3). Hereinafter, descriptions of the technical features that have been described above may not be repeated. Each operation of FIG. 10 is not necessarily an essential operation, and some operations may be omitted.

According to various embodiments, the electronic device may execute a predetermined (e.g., specified) application based on a user input in order to generate an automation pattern. The application may provide a user interface for configuring the conditional clause and resultant clause of the automation pattern. The electronic device may configure the conditional clause and resultant clause of the automation pattern based on a user input through the user interface.

According to various embodiments, in operation 1002, the electronic device may identify at least one communicatively connected external device. The electronic device may establish a communication connection with the at least one external device. The electronic device may establish a communication connection with the at least one external device located in a short distance using a communication module (e.g., the communication module 330 of FIG. 3). For example, the electronic device may establish a communication connection with various home appliances in a home.

According to various embodiments, in operation 1004, the electronic device may receive first operation information from the at least one external device. The electronic device may receive the operation information from the at least one external device. The operation information may include power and various operating characteristics of the external device. For example, when the external device is a light, the operation information may include characteristics such as a brightness and a color of the light, and when the external device is an air conditioner, the operation information may include characteristics such as a cooling temperature, an operating mode, and a wind speed of the air conditioner.

According to various embodiments, in operation 1006, the electronic device may generate the automation pattern based on the first operation information. The automation pattern may include at least one of the conditional clause and the resultant clause, and the conditional clause and resultant clause may include at least one option. The options that can be included in the conditional clause and resultant clauses may include the operating status and time option of the external device. According to an embodiment, the automation pattern generated by the electronic device may include the current operating state of the external device. The electronic device may change at least a portion of the automation pattern based on a user input.

According to various embodiments, in operation 1008, the electronic device may receive second operation information after receiving the first operation information. The electronic device may continuously receive the operation information from the external device. When the operation information of the external device is changed while the electronic device configures the automation pattern, in operation 1010, the electronic device may change the automation pattern based on the second operation information. For example, when the operating state of the external device is changed from a first state to a second state while the electronic device configures the automation pattern, the electronic device may allow the second state of the external device to be included as an option of the resultant clause of the automation pattern.

According to various embodiments, the electronic device may analyze a usage history of the device manipulated by the user and may recommend a frequently used configuration value as automation. The electronic device may generate usage history information based on the operation information received from the external device. The usage history information may include, for example, the operation information of the external device for a predetermined period of time. The electronic device may analyze the usage history information to determine the configuration value that the user frequently uses for the external device. The electronic device may generate the automation pattern based on the determined configuration value.

According to various embodiments, the electronic device may generate the automation pattern according to an operating situation of the external device. Based on the usage history information of the external device, the electronic device may generate an automation routine when there is a trigger that precedes the operation of the external device, and may generate an automation scene when there is no trigger that precedes the operation of the external device.

According to various embodiments, the electronic device may change the automation pattern when the generated automation pattern is different from an actual device operation history. According to an embodiment, in the case in which the electronic device executes the automation pattern, when another external device not included in the automation pattern is always used together, the electronic device may correct the external device to be included in the automation pattern. According to an embodiment, in the case in which the electronic device executes the automation pattern, when the external device is used in an operation different from that configured in the automation pattern, the electronic device may change the operating state of the external device in the automation pattern.

According to various embodiments, the electronic device may provide a function of testing the automation pattern. According to an embodiment, the automation pattern test may be executed only in the case of the automation routine including both the conditional clause and the resultant clause. The electronic device may execute a test for at least one of the options included in the conditional clause. According to an embodiment, the electronic device may classify and display a testable option and an untestable option. For example, a time option may be an impossible condition to be tested. The electronic device may test the automation pattern by assuming a situation in which at least some of testable conditions occur.

According to various embodiments, the electronic device may support a drag-and-drop user interface for intuitively generating the automation pattern. The electronic device may provide a user interface including a list including the at least one external device, a conditional clause box, and a resultant clause box. The electronic device may guide the user to intuitively configure the automation pattern by dragging and dropping the external device selected from the list into the conditional clause box or the result clause box.

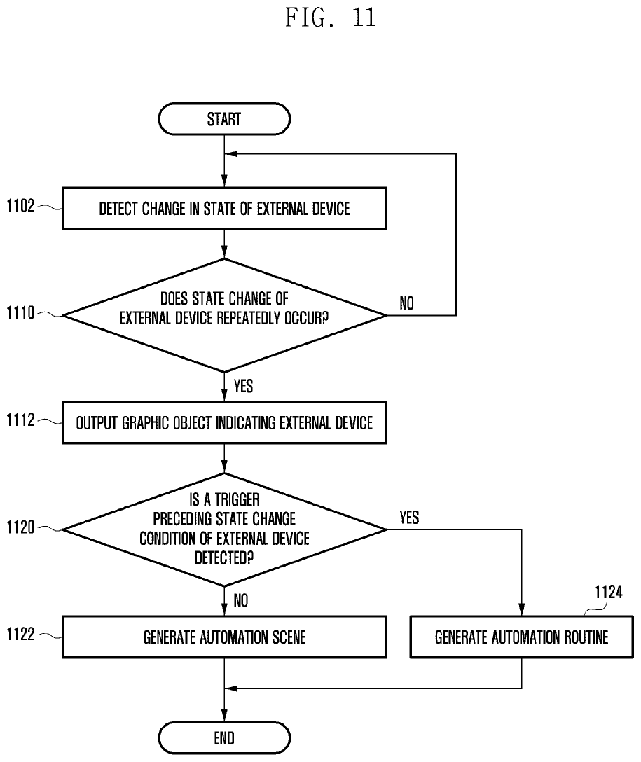

FIG. 11 is a flowchart illustrating an example method of generating an automation pattern or an automation scene by an electronic device according to various embodiments.

According to various embodiments, in operation 1102, the electronic device may detect a change in the state of the external device. The electronic device may continuously receive operation information including information on the operating state from the at least one external device, and may compare the previously received operation information with currently received operation information to detect the change in the state of the external device.

According to various embodiments, in operation 1110, the electronic device may determine whether the state change of the external device repeatedly occurs. The electronic device may store the received operation information of the at least one external device in a memory (e.g., the memory 340 of FIG. 3). The electronic device may determine whether the external device is repeatedly used in a specific operating state based on the usage history of the at least one external device stored in the memory 340.

According to various embodiments, in operation 1112, the electronic device may output a graphic object indicating the external device when the state change of the external device repeatedly occurs (YES in 1110). The electronic device may generate an automation pattern including the external device that is repeatedly used in the specific operating state. The electronic device may output a graphic object corresponding to the at least one external device included in the automation pattern to a display (e.g., the display 320 of FIG. 3). According to an embodiment, the electronic device may additionally output an indicator indicating the operating state of the external device corresponding to one side of the graphic object.

According to various embodiments, in operation 1120, the electronic device may determine whether there is a trigger that precedes the state change of the external device. For example, it may be determined whether the operation of the second external device in the second operating state proceeds the operation of the first external device in the first operating state. The electronic device may determine whether a frequency at which the first external device and the second external device operate together satisfies a designated condition. When the frequency at which the second external device operates satisfies the designated condition, the electronic device may determine that there is the trigger that precedes the state change of the external device. Conversely, when the frequency at which the external devices operate does not satisfy the designated condition, the electronic device may determine that there is no trigger that precedes the state change of the external devices.

According to an embodiment, in operation 1122, when there is no trigger (NO in 1120), the electronic device may generate the automation scene. The automation scene may be an automation pattern including only resultant clauses without including conditional clauses. The electronic device may execute the automation scene based on a user input. According to an embodiment, in operation 1124, the electronic device may generate the automation routine when there is the trigger. The automation routine may be an automation pattern that includes both the conditional and resultant clauses. The electronic device may execute options included in the resultant clause when an event that satisfies all options included in the conditional clause occurs without a user's separate input.

Embodiments of the disclosure herein and drawings are merely presented as examples to easily explain the technical content of the disclosure and aid in understanding of the disclosure, and are not intended to limit the scope of the disclosure. It is will be apparent to those skilled in the art that other modified examples based on the technical idea of the disclosure can be implemented in addition to the embodiments disclosed herein.

A method of generating an automation pattern of an electronic device according to various example embodiments may include: receiving, from at least one communicatively connected external electronic device, first operation information on an operating state of the at least one external electronic device; generating an automation pattern including an operation of the at least one external electronic device based on the first operation information; receiving second operation information on the operating state of the at least one external electronic device from the at least one external electronic device after the reception of the first operation information; changing the automation pattern between a change between the operating state of the at least one external electronic device included in the first operation information and the operating state of the at least one external electronic device included in the second operation information; and executing the automation pattern based on an input.

According to various example embodiments, the changing of the automation pattern may include detecting, based on changing the operating state of the at least one external electronic device, that the operating state of the at least one external device is changed in real time, and changing the automation pattern in response to detecting that the operating state of the at least one external device is changed.

According to various example embodiments, the generating of the automation pattern may include generating an automation pattern including both at least one conditional clause including an operating condition of the automation pattern and at least one resultant clause including an operating result, or an automation pattern including only the at least one resultant clause.

According to various example embodiments, the generating of the automation pattern may include generating usage history information of each external device based on the operation information received from the at least one external device, and generating the automation pattern based on the usage history information.

According to various example embodiments, the generating of the automation pattern may include determining whether a frequency at which the external device operates in a specific operating state satisfies a designated condition based on the usage history information, identifying, based on the frequency satisfying the designated condition, whether there is a trigger that precedes the specific operating state, and generating an automation pattern including the at least one conditional clause and the at least one resultant clause based on there being the trigger and generating an automation pattern including only the at least one resultant clause based on there being no trigger.

According to various example embodiments, the changing of the automation pattern may include receiving the operation information from the external device based on the automation pattern being executed, and changing, based on there being a difference between the operation information and the automation pattern, the automation pattern based on the difference.

According to various example embodiments, the method may further include providing a test function of the generated automation pattern.

According to various example embodiments, the providing of the test function may include providing the test function by determining at least one of the conditional clauses included in the automation pattern as a testable conditional clause.

According to various example embodiments, the generating of the automation pattern may include outputting at least one graphic object including an indicator indicating the operating state of the at least one external device to the display based on the first operation information, and changing the at least one graphic object and outputting the changed graphic object to the display based on a difference between the operating state of the at least one external device included in the first operation information and the operating state of the at least one external device included in the second operation information.

According to various example embodiments, the generating of the automation pattern may include activating a position movement, based on a drag input to a graphic object corresponding to the external electronic device, of the graphic object within the display, and a conditional clause box and a resultant clause box, and generating the automation pattern in response to the graphic object being dropped in the conditional clause box or the resultant clause box.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a communication module comprising communication circuitry;
a memory; and
a processor operatively connected to the display, the communication module, and the memory,
wherein the processor is configured to:
receive, from at least one communicatively connected external electronic device, first operation information on an operating state of the at least one external electronic device;
generate an automation pattern comprising an operation of the at least one external electronic device, based on the first operation information;
receive second operation information on the operating state of the at least one external electronic device from the at least one external electronic device after the reception of the first operation information;
change the automation pattern, based on a difference between the operating state of the at least one external electronic device included in the first operation information and the operating state of the at least one external electronic device included in the second operation information; and
execute the automation pattern, based on an input.

2. The electronic device of claim 1, wherein the processor is configured to:
based on changing the operating state of the at least one external electronic device, detect that the operating state of the at least one external device is changed in real time; and
change the automation pattern in response to detecting that the operating state of the at least one external device is changed.

3. The electronic device of claim 1, wherein the processor is configured to generate an automation pattern comprising both at least one conditional clause including an operating condition of the automation pattern and at least one resultant clause including an operating result, or an automation pattern comprising only the at least one resultant clause.

4. The electronic device of claim 3, wherein the processor is configured to:
generate usage history information of each external device, based on the operation information received from the at least one external device; and
generate the automation pattern, based on the usage history information.

5. The electronic device of claim 4, wherein the processor is configured to:
determine whether a frequency at which the external device operates in a specific operating state satisfies a designated condition, based on the usage history information;
based on the frequency satisfying the designated condition, identify whether there is a trigger that precedes the specific operating state;
generate an automation pattern comprising the at least one conditional clause and the at least one resultant clause based on there being the trigger; and
generate an automation pattern comprising only the at least one resultant clause based on there being no trigger.

6. The electronic device of claim 1, wherein the processor is configured to:
receive the operation information from the external device based on the automation pattern being executed; and
based on there being a difference between the operation information and the automation pattern, change the automation pattern, based on the difference.

7. The electronic device of claim 3, wherein the processor is configured to provide a test function of the generated automation pattern.

8. The electronic device of claim 7, wherein the processor is configured to determine at least one of the conditional clauses included in the automation pattern as a testable conditional clause to provide a test function.

9. The electronic device of claim 1, wherein the processor is configured to:
output at least one graphic object comprising an indicator indicating the operating state of the at least one external device to the display, based on the first operation information; and
change the at least one graphic object and output the changed graphic object to the display, based on a difference between the operating state of the at least one external device included in the first operation information and the operating state of the at least one external device included in the second operation information.

10. The electronic device of claim 9, wherein the processor is configured to:
activate a position movement, based on a drag input to a graphic object corresponding to the external electronic device, of the graphic object within the display, and a conditional clause box and a resultant clause box; and
generate the automation pattern in response to the graphic object being dropped in the conditional clause box or the resultant clause box.

11. A method of generating an automation pattern of an electronic device, the method comprising:
receiving, from at least one communicatively connected external electronic device, first operation information on an operating state of the at least one external electronic device;
generating an automation pattern comprising an operation of the at least one external electronic device, based on the first operation information;
receiving second operation information on the operating state of the at least one external electronic device from the at least one external electronic device after the reception of the first operation information;
changing the automation pattern, based on a change between the operating state of the at least one external electronic device included in the first operation information and the operating state of the at least one external electronic device included in the second operation information; and
executing the automation pattern, based on an input.

12. The method of claim 11, wherein the changing of the automation pattern comprises:
based on changes to the operating state of the at least one external electronic device, detecting that the operating state of the at least one external device is changed in real time; and
changing the automation pattern in response to detecting that the operating state of the at least one external device is changed.

13. The method of claim 11, wherein the generating of the automation pattern comprises
generating an automation pattern comprising both at least one conditional clause including an operating condition of the automation pattern and at least one resultant clause including an operating result, or an automation pattern comprising only the at least one resultant clause.

14. The method of claim 13, wherein the generating of the automation pattern comprises:
generating usage history information of each external device, based on the operation information received from the at least one external device; and
generating the automation pattern, based on the usage history information.

15. The method of claim 14, wherein the generating of the automation pattern comprises:
determining whether a frequency at which the external device operates in a specific operating state satisfies a designated condition, based on the usage history information;
based on the frequency satisfying the designated condition, identifying whether there is a trigger that precedes the specific operating state; and
generating an automation pattern comprising the at least one conditional clause and the at least one resultant clause based on there being the trigger, and generating an automation pattern comprising only the at least one resultant clause based on there being no trigger.

16. The method of claim 11, wherein the changing of the automation pattern comprises:
receiving the operation information from the external device based on the automation pattern being executed; and
based on there being a difference between the operation information and the automation pattern, changing the automation pattern, based on the difference.

17. The method of claim 13, comprising providing a test function of the generated automation pattern.

18. The method of claim 17, wherein the providing of the test function comprises providing the test function by determining at least one of the conditional clauses included in the automation pattern as a testable conditional clause.

19. The method of claim 11, wherein the generating of the automation pattern comprises:
outputting at least one graphic object comprising an indicator indicating the operating state of the at least one external device to the display, based on the first operation information; and
changing the at least one graphic object and outputting the changed graphic object to the display, based on a difference between the operating state of the at least one external device included in the first operation information and the operating state of the at least one external device included in the second operation information.

20. The method of claim 19, wherein the generating of the automation pattern comprises:
activating a position movement, based on a drag input to a graphic object corresponding to the external electronic device, of the graphic object within the display, and a conditional clause box and a resultant clause box; and
generating the automation pattern in response to the graphic object being dropped in the conditional clause box or the resultant clause box.
